(19) United States
(12) Patent Application Publication
(10) Pub. No.: US 2025/0217126 A1
(43) Pub. Date: Jul. 3, 2025

(54) LARGE LANGUAGE MODEL CODE TRANSLATION ERROR DETECTION

(71) Applicant: INTERNATIONAL BUSINESS MACHINES CORPORATION, ARMONK, NY (US)

(72) Inventors: ANDREW C. M. HICKS, HIGHLAND, NY (US); MICHAEL GAGLIARDI, SOMERSET, MA (US); RYAN LO, POUGHKEEPSIE, NY (US)

(21) Appl. No.: 18/398,322

(22) Filed: Dec. 28, 2023

(51) Int. Cl. G06F 8/51; G06F 11/36

(52) U.S. Cl. CPC G06F 8/51; G06F 11/3604

(57) ABSTRACT

Large language model code translation error detection include receiving a code portion of a first programming language, and converting the code portion to a second programming language. A first accuracy of the converting of the code portion to the second programming language is calculated. A difference between the first accuracy and an historical accuracy of a conversion from the first programming language to the second programming language is determined. A potential error in the code portion of the first programming language is indicated based on the difference between the first accuracy and the historical accuracy being greater than a predetermined value is indicated.

### BACKGROUND

The present disclosure relates to methods, apparatus, and products for large language model code translation error detection. Migrating the functionality of legacy source code to a more modern programming language can increase the maintainability and readability of the source code as well as improve system performance. However, such a migration is an arduous task that can include writing, testing, validating, and debugging massive amounts of code. If the modernized source code is deployed with errors into a complex software system, expected operations may fail to complete, exhaustive retry logic may hog resources, transactions can begin to fail, and entire components of the stack may fail, leading to a potential outage. This can be disastrous, especially in core production systems.

### SUMMARY

According to embodiments of the present disclosure, various methods, apparatus and products for large language model code translation error detection are described herein. In some aspects, a method for large language model code translation error detection includes receiving a code portion of a first programming language; converting the code portion to a second programming language; calculating a first accuracy of the converting of the code portion to the second programming language; determining a difference between the first accuracy and an historical accuracy of a conversion from the first programming language to the second programming language; and indicating a potential error in the code portion of the first programming language based on the difference between the first accuracy and the historical accuracy being greater than a predetermined value.

In an embodiment, calculating the first accuracy of the converting of the code portion to the second programming language further comprises: calculating a first code structure representation of the code portion of the first programming language; calculating a second code structure representation of the converted code portion of the second programming language; and calculating the first accuracy based on a comparison of the first code structure representation to the second code structure representation.

In an embodiment, calculating the first code structure representation of the code portion of the first programming language further comprises calculating the first code structure representation of the code portion of the first programming language based on one or more software metrics. In an embodiment, calculating the second code structure representation of the converted code portion of the second programming language further comprises calculating the second code structure representation of the converted code portion of the second programming language based on the one or more software metrics. In an embodiment, the one or more software metrics include code complexity metrics.

In an embodiment, calculating the first code structure representation of the code portion of the first programming language based on one or more software metrics further comprises calculating the first code structure representation of the code portion of the first programming language based on a weighted combination of a plurality of the one or more software metrics.

In an embodiment, the method includes determining the historical accuracy based on an accuracy of at least one previous conversion of another code portion from the first programming language to the second programming language.

In an embodiment, converting the code portion to a second programming language comprises converting the code portion to a second programming language using a generative artificial intelligence model. In an embodiment, the generative artificial intelligence model comprises a large language model.

In an embodiment, indicating the potential error in the code portion based on the difference between the first accuracy and the historical accuracy being greater than a predetermined value further comprises providing an indication of the potential error in the code portion to the generative artificial intelligence model.

In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for large language model code translation error detection in accordance with some embodiments of the present disclosure.

FIG. 2 sets forth a flowchart of an example method for large language model code translation error detection in accordance with some embodiments of the present disclosure.

FIG. 3 sets forth a flowchart of another example method for large language model code translation error detection in accordance with some embodiments of the present disclosure.

FIG. 4 sets forth a flowchart of another example method for large language model code translation error detection in accordance with some embodiments of the present disclosure.

FIG. 5 sets forth a flowchart of another example method for large language model code translation error detection in accordance with some embodiments of the present disclosure.

### DETAILED DESCRIPTION

The advent of large language models and other improvements to artificial intelligence (AI) technology have enabled AI to generate source code. Large language models (LLMs), for example, are trained on massive datasets of source code to provide generative AI that outputs source code based on some input or prompt. As will discussed in further detail below, the migration of an application from its original source code to new source code can be assisted by such AI. That is, the AI can be used to generate new source code based on an input of original source code. For example, an LLM may be given a prompt such as “Generate Java code that achieves the same objectives as the following COBOL code,” where the legacy COBOL source code is provided as an input. In response, the LLM may output, at least ideally, AI-generated Java source code that performs the same functions and produces the same output as the legacy. Of course, any new source code, whether human or AI generated, is susceptible to the introduction of bugs, execution errors, or other faults.

Embodiments in accordance with the present disclosure advantageously utilize historical accuracy data to detect potential bugs, execution errors, or other faults in the original source code in a first programming language (e.g., COBOL) that are subsequently translated into converted source code in a second programming language (e.g., Java). LLMs have significantly advanced the process of translating code from one programming language to another. However, challenges arise when the translated output code deviates from an acceptable standard. In such situations, it is difficult to determine whether errors in the translated source code arises from a translation error or an underlying error in the original source code. Various embodiments recognize that this discrepancy between accurate translation for a good input and suboptimal results for a bad input can function as an indicator that the original source code should be corrected before translating the source code again.

In a particular example, an LLM used to convert COBOL to Java produces a particular accuracy of translation that is acceptable within a standard deviation under an assumption that the COBOL is written correctly without bugs. However, should the COBOL contain bugs or errors, an accurate translation of the “bugged” COBOL will be “bugged” Java. As a result, the accuracy of the code translation may decrease drastically below the standard deviation, potentially indicating an error in the input COBOL. A drop in translation accuracy from a historical accuracy of translating COBOL to Java may give rise to an assumption of either that the LLM is translating code that it hasn't seen before or there is an error in the source code. In an example, a drop in accuracy of 20% from the expected accuracy gives rise to an assumption with 80% certainty that there is a bug in the COBOL code.

By identifying potential errors in the original source code, the original source code can be reviewed to identify the potential errors. Once the errors are corrected, the original source code can be translated again using the LLM to produce a more accurate converted code. The process can be iterated until an acceptable accuracy of translation is achieved.

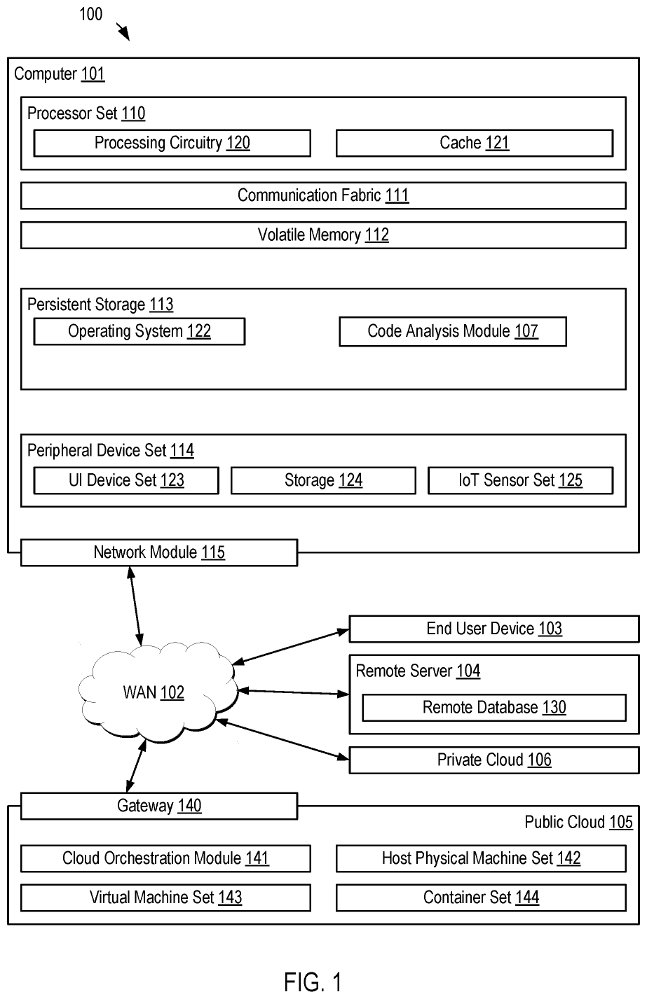

With reference now to FIG. 1, shown is an example computing environment according to aspects of the present disclosure. Computing environment 100 contains an example of an environment for the execution of at least some of the computer code involved in performing the various methods described herein, such as the code analysis module 107. In addition to the code analysis module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code analysis module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in code analysis module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in code analysis module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

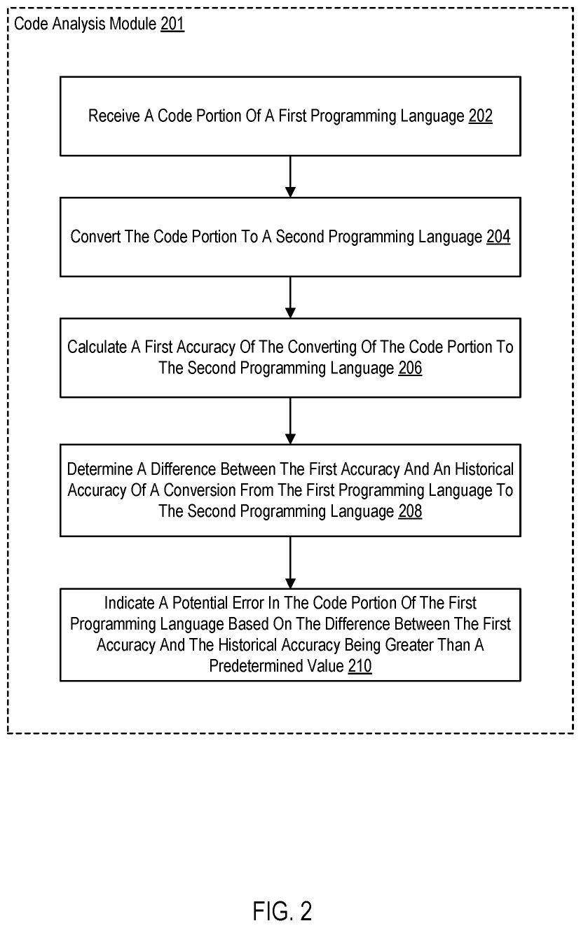

For further explanation, FIG. 2 sets forth a flowchart of an example method for large language model code translation error detection in accordance with some embodiments of the present disclosure. The method of FIG. 2 may be performed, for example, by a code analysis module 201 such as the code analysis module 107 of FIG. 1. In some embodiments, the code analysis module 201 may be implemented as a process or service separate from an application or software implementing code analysis. For example, the code analysis module 201 may be implemented by an operating system or other software that monitors the behavior and execution of an application implementing code analysis. As another example, in some embodiments, the code analysis module 201 may be implemented as a process or service that applies modifications to applications implementing code analysis.

The method of FIG. 2 includes receiving 202 a code portion of a first programming language, and converting 204 the code portion to a second programming language. Although FIG. 2 describes execution of an application, it is understood that the approaches set forth herein may be applied to any software or module capable of implementing code analysis, including applications, operating systems, libraries, and the like. In an example, the code portion may include legacy source code written in an older programming language (e.g., COBOL) and the converted code portion may include code written in a modern programming language (e.g., Java). In a particular example, both the code portion and the converted code portion are intended to achieve the same objectives, provide the same interfaces, and produce the same output. In particular examples, the code portion may include an application, a subroutine, a function, or driver. In an embodiment, the code portion is translated from the first programming language to the second programming language using generative AI such as an LLM. In some examples, some or all of the converted code is generated utilizing an AI language model. For example, some or all of the original source code can be provided as an input to the AI language model with a request (e.g., a prompt) to generate source code in a different programming language that achieves the same objectives as the original source code.

In an embodiment, the code analysis module 201 calculates 206 a first accuracy of the converting of the code portion to the second programming language. In a particular embodiment, the first accuracy indicates a degree of accuracy of the translation from the original source code to the converted source code. In one or more embodiments, the first accuracy of the converting of the code portion to the second programming language is based on a comparison of the code structures of the original code portion and the converted code portion for similarity within a predetermined acceptable threshold. In a particular embodiment, a first code structure representation of the code portion of the first programming language and a second code structure representation of the converted code portion of the second programming language are calculated. The first code structure representation and the second code structure representation are compared to calculate the first accuracy.

In one or more embodiments, calculating the first code structure representation of the code portion of the first programming language and the second code structure representation of the converted code portion of the second programming language is based on one or more software metrics. In a particular embodiment, an abstract syntax tree (AST) is used to calculate the first accuracy of the converting of the code portion to the converted code portion. An AST is a data structure used to represent the structure of the code portion in a tree representation of the abstract syntactic structure of text of the programming language. Each node of the tree denotes a construct occurring in the text. The syntax is “abstract” in the sense that it does not represent every detail appearing in the real syntax, but rather just the structural or content-related details. Compared to the source code, the AST does not typically include inessential punctuation and delimiters. By comparing ASTs of the original code portion and the converted code portion, a measure of the accuracy of the converting is calculated.

In another embodiment, one or more code complexity metrics are used to calculate a respective code complexity for each of the original code portion and the converted code portion. Correctly translated source code is expected to exhibit a similar degree of complexity as the original source code. In one or more embodiments, comparing the code complexities of the original source code portion to the converted code portion is a potential indicator of a logical error, fault, bug or other programming error in the original source code portion.

In an example, a cyclomatic complexity metric is used to calculate the complexity of the original code portion and the converted code portion. The cyclomatic complexity metric represents the number of linearly independent paths through the source code. A path is linearly independent if there is a subset of one or more paths in which the symmetric difference of their edge sets is empty. For example, if the source code contains no control flow statements, the complexity is 1 since there is only a single path through the code. If the source code includes a single conditional statement, there are two paths through the code indicating a complexity of 2.

In another example, a Halstead complexity metric is used to calculate the complexity of the original code portion and the converted code portion. The Halstead complexity metric is computed statistically without program execution and takes into account factors such as the number of distinct operators, the number of distinct operands, the total number of operators, and the total number of operands. In another example, a Maintainability Index metric is used to calculate the complexity of the original code portion and the converted code portion. The Maintainability Index metric is calculated to represent the relative ease of maintaining the code portion and is calculated based on the number of statements in the code, the cyclomatic complexity, and the Halstead volume (computed as a function of the code length, number of distinct operators, and number of distinct operands).

In another embodiment, calculating the first code structure representation of the code portion of the first programming language and the second code structure representation of the converted code portion of the second programming language is based on a combination of the one or more software metrics. In a particular embodiment, calculating the first code structure representation of the code portion of the first programming language and the second code structure representation of the converted code portion of the second programming language is based on a weighted combination of a plurality of the one or more software metrics. For example, one or more of the software metrics may be weighted differently than other software metrics in calculating the respective code structure.

In an embodiment, the code analysis module 201 determines 208 a difference between the first accuracy and an historical accuracy of a conversion from the first programming language to the second programming language. In an embodiment, the historical accuracy is based on an accuracy of at least one previous conversion of another code portion from the first programming language to the second programming language. In a particular embodiment, accuracy determinations of previous conversions of code from the first programming language to the second programming language are used to determine an expected accuracy within a particular deviation of translation of the conversion of code programmed using the first programming language to converted code of the second programming language. In a particular embodiment, the previously determined accuracy information is used to construct an accuracy model of code translation from the first programming language to the second programming language.

In an embodiment, the code analysis module 201 indicates 210 a potential error in the code portion of the first programming language based on the difference between the first accuracy and the historical accuracy being greater than a predetermined value. In a particular example, the code analysis module 201 indicates 210 a potential error in the code portion of the first programming language if the difference between the first accuracy and the historical accuracy is greater than 20%. In an example, the indication of the potential error in the code portion is used to review the code portion for errors, correct the errors, and perform conversion of the code portion in the first programming language to the second programming language using the corrected code. In particular embodiments, the process is iteratively repeated until an acceptable accuracy is obtained. In another embodiment, the indication further includes a probability of an error in the code portion.

In another embodiment, the code analysis module 201 determines that the difference between the first accuracy and the historical accuracy is less than the predetermined value, determines that the converted code portion is unexecutable, and indicates that the converted code portion is unexecutable. In particular embodiments, determining that the converted code portion is unexecutable includes determining that the converted code portion is uncompilable or includes one or more errors.

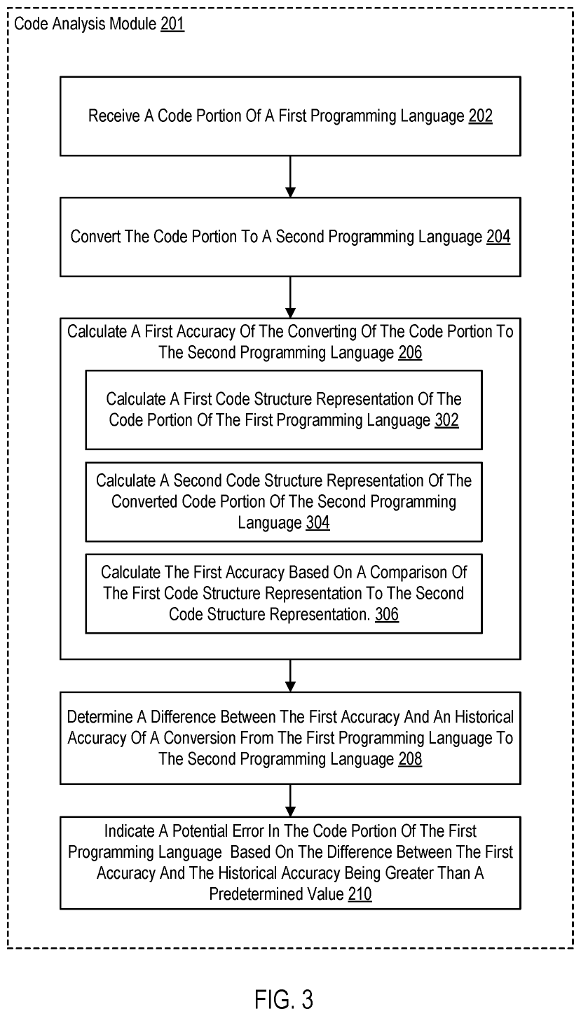

For further explanation, FIG. 3 sets forth a flowchart of another example method for large language model code translation error detection in accordance with some embodiments of the present disclosure. The method of FIG. 3 extends the method of FIG. 2 in that calculating 206 the first accuracy of the converting of the code portion to the second programming language includes calculating 302 a first code structure representation of the code portion of the first programming language, and calculating 304 a second code structure representation of the converted code portion of the second programming language. The method of FIG. 3 further includes calculating 306 the first accuracy based on a comparison of the first code structure representation to the second code structure representation.

In an embodiment, calculating the first code structure representation of the code portion of the first programming language is based on one or more software metrics. In an embodiment, calculating the second code structure representation of the converted code portion of the second programming language is also based on the one or more software metrics. In one or more embodiments, the one or more software metrics include code complexity metrics. In an embodiment, calculating the first code structure representation of the code portion of the first programming language is based on a weighted combination of a plurality of the one or more software metrics.

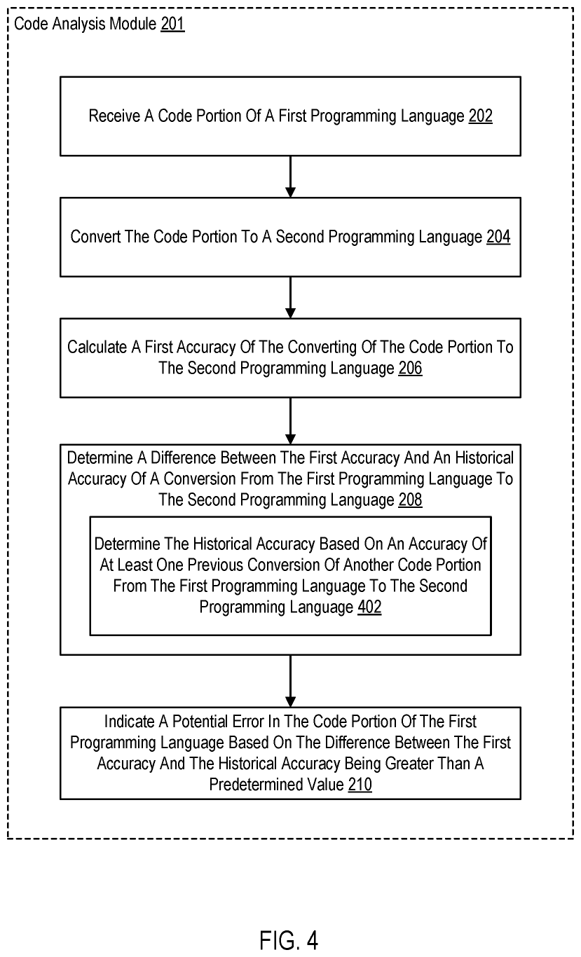

For further explanation, FIG. 4 sets forth a flowchart of another example method for large language model code translation error detection in accordance with some embodiments of the present disclosure. The method of FIG. 4 extends the method of FIG. 2 in that determining 208 the difference between the first accuracy and an historical accuracy of a conversion from the first programming language to the second programming language includes determining 402 the historical accuracy based on an accuracy of at least one previous conversion of another code portion from the first programming language to the second programming language.

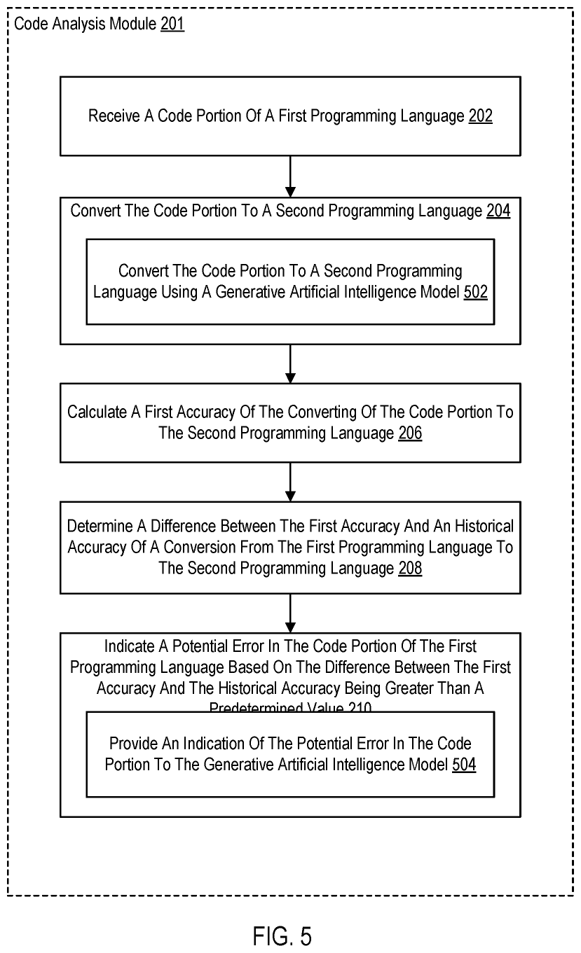

For further explanation, FIG. 5 sets forth a flowchart of another example method for large language model code translation error detection in accordance with some embodiments of the present disclosure. The method of FIG. 5 extends the method of FIG. 2 in that converting 204 the code portion to the second programming language includes converting 502 the code portion to a second programming language using a generative artificial intelligence model. In a particular embodiment, the generative artificial intelligence model includes a large language model.

The method of FIG. 5 further extends the method of FIG. 2 in that indicating 210 the potential error in the code portion of the first programming language based on the difference between the first accuracy and the historical accuracy being greater than a predetermined value includes providing 504 an indication of the potential error in the code portion to the generative artificial intelligence model. In a particular embodiment, the generative artificial intelligence model is further trained based on the indication of the potential error in the code portion of the first programming language. In a particular example, the generative artificial intelligence model disregards the code portion from being used in training based on the indicated potential of the error in the code portion.

The above-described examples are provided in the context of translation error detection when migrating an application from original source code to new source code. It will be appreciated that the term ‘original source code’ as used herein refers to the instance of the application against which the new source code is being validated for accuracy, and should not be construed as limiting the term to mean the earliest implementation of that application. While embodiments are useful in migrating or porting an application from one programming language to a different programming language, and from legacy code to a more modernized programming language, it will be further appreciated that in some examples the original source code and the new source code may be written in the same programming language.

In view of the foregoing, large language model code translation error detection in accordance with the present disclosure provides a number of advantages. Identification of errors within original source code provides for greater success in producing accurate conversions of the original source code to new source code of a different programming language. Such errors can be corrected to enable the conversion of the source original source code to new source code to increase accuracy of the new source code and prevent or reduce execution errors int the converted code.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a code portion of a first programming language;
converting the code portion to a second programming language;
calculating a first accuracy of the converting of the code portion to the second programming language;
determining a difference between the first accuracy and an historical accuracy of a conversion from the first programming language to the second programming language; and
indicating a potential error in the code portion of the first programming language based on the difference between the first accuracy and the historical accuracy being greater than a predetermined value.

2. The method of claim 1, wherein calculating the first accuracy of the converting of the code portion to the second programming language further comprises:
calculating a first code structure representation of the code portion of the first programming language;
calculating a second code structure representation of the converted code portion of the second programming language; and
calculating the first accuracy based on a comparison of the first code structure representation to the second code structure representation.

3. The method of claim 2, wherein calculating the first code structure representation of the code portion of the first programming language further comprises calculating the first code structure representation of the code portion of the first programming language based on one or more software metrics.

4. The method of claim 3, wherein calculating the second code structure representation of the converted code portion of the second programming language further comprises calculating the second code structure representation of the converted code portion of the second programming language based on the one or more software metrics.

5. The method of claim 4, wherein the one or more software metrics include code complexity metrics.

6. The method of claim 3, wherein calculating the first code structure representation of the code portion of the first programming language based on one or more software metrics further comprises calculating the first code structure representation of the code portion of the first programming language based on a weighted combination of a plurality of the one or more software metrics.

7. The method of claim 1, further comprising:
determining the historical accuracy based on an accuracy of at least one previous conversion of another code portion from the first programming language to the second programming language.

8. The method of claim 1, wherein converting the code portion to a second programming language comprises converting the code portion to a second programming language using a generative artificial intelligence model.

9. The method of claim 8, wherein the generative artificial intelligence model comprises a large language model.

10. The method of claim 8, wherein indicating the potential error in the code portion based on the difference between the first accuracy and the historical accuracy being greater than a predetermined value further comprises providing an indication of the potential error in the code portion to the generative artificial intelligence model.

11. The method of claim 1, further comprising:
determining that the difference between the first accuracy and the historical accuracy is less than the predetermined value;
determining that the converted code portion is unexecutable; and
indicating that the converted code portion is unexecutable.

12. An apparatus comprising:
a processing device; and
memory operatively coupled to the processing device, wherein the memory stores computer program instructions that, when executed, cause the processing device to:
receive a code portion of a first programming language;
convert the code portion to a second programming language;
calculate a first accuracy of the converting of the code portion to the second programming language;
determine a difference between the first accuracy and an historical accuracy of a conversion from the first programming language to the second programming language; and
indicate a potential error in the code portion of the first programming language based on the difference between the first accuracy and the historical accuracy being greater than a predetermined value.

13. The apparatus of claim 12, wherein the computer program instructions that, when executed to calculate the first accuracy of the converting of the code portion to the second programming language, cause the processing device to:
calculate a first code structure representation of the code portion of the first programming language;
calculate a second code structure representation of the converted code portion of the second programming language; and
calculate the first accuracy based on a comparison of the first code structure representation to the second code structure representation.

14. The apparatus of claim 13, wherein calculating the first code structure representation of the code portion of the first programming language further comprises calculating the first code structure representation of the code portion of the first programming language based on one or more software metrics.

15. The apparatus of claim 14, wherein calculating the second code structure representation of the converted code portion of the second programming language further comprises calculating the second code structure representation of the converted code portion of the second programming language based on the one or more software metrics.

16. The apparatus of claim 15, wherein the one or more software metrics include code complexity metrics.

17. A computer program product comprising a computer readable storage medium, wherein the computer readable storage medium comprises computer program instructions that, when executed:
receive a code portion of a first programming language;
convert the code portion to a second programming language;
calculate a first accuracy of the converting of the code portion to the second programming language;
determine a difference between the first accuracy and an historical accuracy of a conversion from the first programming language to the second programming language; and
indicate a potential error in the code portion of the first programming language based on the difference between the first accuracy and the historical accuracy being greater than a predetermined value.

18. The computer program product of claim 17, wherein the computer program instructions that, when executed to calculate the first accuracy of the converting of the code portion to the second programming language:
calculate a first code structure representation of the code portion of the first programming language;
calculate a second code structure representation of the converted code portion of the second programming language; and
calculate the first accuracy based on a comparison of the first code structure representation to the second code structure representation.

19. The computer program product of claim 18, wherein calculating the first code structure representation of the code portion of the first programming language further comprises calculating the first code structure representation of the code portion of the first programming language based on one or more software metrics.

20. The computer program product of claim 19, wherein calculating the second code structure representation of the converted code portion of the second programming language further comprises calculating the second code structure representation of the converted code portion of the second programming language based on the one or more software metrics.
